(19) United States
(12) Patent Application Publication
(10) Pub. No.: US 2023/0289804 A1
(43) Pub. Date: Sep. 14, 2023

(54) METHOD FOR SCORING EVENTS FROM MULTIPLE HETEROGENEOUS INPUT STREAMS WITH LOW LATENCY, USING MACHINE LEARNING

(71) Applicant: FRAUDIO HOLDING B.V., Amsterdam (NL)

(72) Inventor: João Manuel GOMES MOURA, Amsterdam (NL)

(21) Appl. No.: 18/007,448

(22) PCT Filed: Jul. 31, 2020
(86) PCT No.: PCT/IB2020/057264

§ 371 Date: Jan. 30, 2023

(51) Int. Cl. G06Q 20/40; G06N 5/022

(52) U.S. Cl. CPC G06Q 20/4016; G06N 5/022

(57) ABSTRACT

The present invention relates to a method and system for applying a centralized artificial intelligence system, trained in batch, using a centralised data set having a known dataset schema, to score events from multiple heterogeneous streams of data.

### SCOPE OF THE INVENTION

The invention described in this document relates to a method and system for applying a centralized artificial intelligence system, trained in batch, using a centralised data set having a known dataset schema, to score events from multiple heterogeneous streams of data.

The invention described in this document uses a new method and system based on artificial intelligence that will eliminate the deficiencies present on current vendors’ systems.

The invention is based on automatically integrating a fraud detection model, by mapping the schema of a previously unseen stream of events into the schema of a known stream of events, which has been used to train a set of Artificial Intelligence models.

In two preferred example embodiments, it is presented an application of the system to multiple streams of card payment transactions, each with its own different dataset schemas, and to multiple streams of money transactions to respectively detect payment fraud and money laundering.

### TECHNICAL FIELD OF THE INVENTION

Online payment fraud costs global businesses close to 2% of their revenue. Because retailers have slim margins they can end up losing 10% to more than 25% of their profits. Due to these large losses on fraud, there is a high demand for fraud detection solutions and many exist in the market.

Where fraud analysts were previously performing manual analysis and rule based systems to detect fraud, it is now far from optimal to perform such detection due to the improving technologies that have become available over the past years.

All top tier current vendors offer fraud detection systems that use artificial intelligence. These systems were created to facilitate analysis and to automate decision making. The application and use of artificial intelligence effectively improved the accuracy of fraud detection.

The detection systems that these vendors offer are all professional services based though. Usually the steps of professional services based integration of detection systems includes at least:
● Historical data transfer, customer collects and transfers historical data to the vendor
● Data science teams get assigned to work with that customer’s data
● Custom product development, training and optimizing customized machine learning models and often also rules
● Testing the product locally to discover problems
● Deployment and hosting of the product.

The downside of such a process is that it is invariably lengthy and expensive. The time between the decision of committing and going live generally takes between six months and a year.

Old learnings are not reused and data from one customer is not used to help the other ones. Take for instance a card issuing bank. A vendor processing their transactions will have access to every payment done using this bank’s cards. The typical vendor will produce machine learning models that will learn from behaviours and patterns typical of this bank’s customers. If the same vendor also processes transactions from another bank, in the same country, it will isolate the data sets from these two customers and produce individual machine learning models, which will not be able to produce stronger insights by taking advantage of the fact that the vendor has access to a lot of data from the same segment. Often this forced segregation is not able to capture underlying patterns and behaviours that are customer independent and that occur homogeneously across one specific segment.

Most modern fraud detection mechanisms are based on machine learning methods and detect larger fractions of fraudulent transactions than ever before. Fraud detection increasingly determines a company’s value proposition and therefore becomes proprietary technology that is isolated within banks, credit card networks or schemes and payment service providers. Even if they did share their records to create a more accurate model, the integration costs would be immense. Credit and debit card transaction records are collected by all of them, but there is no unifying standard, making this data highly diverse. This reinforces already secluded data silos within each company and prevents any sort of aggregation, thereby failing to leverage the total amount of data the payment industry already has.

It is also the case that existing vendors need to start over from scratch for each new project. They need to go through lengthy data exploration processes, and then write complex machine learning pipelines for each of their new customers.

The present invention relates generally to a method and system for applying a centralized artificial intelligence system, trained in batch using a centralised data set having a known dataset schema, to score events from multiple streams of data, more particularly to fraud detection and even more particularly to a method and system for applying one single centralised set of artificial intelligence models in real real-time (<200 ms) to multiple streams of card payment transactions.

The present invention aggregates such data sets and proposes advanced approaches to transform a new data set schema (the source) into a known data set schema (the target). The multiple streams of card payment transactions will each have their own dataset schema.

This is a novel approach to the problem of fraud detection within card payment transactions, as it is opposed to having different artificial intelligence models specifically trained for each stream of card payment transactions.

### BACKGROUND OF THE INVENTION

Different methods relating to the fraud detection within card payment transactions are known in the art.

Examples of methods to detect frauds related to card payment transactions may be found in document US2015039512 and in document US2019073647.

Document US2015039512 relates to a real-time financial fraud management system, more particularly to a back-end cross-channel fraud detection and protection systems.

Document US2015039512 discloses a method that uses a parallel arrangement of fraud models that utilize several artificial intelligence classifiers like neural networks, case based reasoning, decision trees, genetic algorithms, fuzzy logic and rules and constraints.

Document US2015039512 describes a method for achieving fraud detection within the field of payments, but relies on human interaction for application to a commercial client. This method does not make use of precomputed aggregate values that will enable the system to provide context to the input transactions to be scored in real time.

Document US2019073647 relates to a card payment transaction fraud detection method that incorporates card issuer bin and cardholder location associated with a multitude of customers. The techniques disclosed by document US2019073647 refer to the use of an artificial intelligence computing system that receives training data from human supervision of the fraud detection model. This model does not make use of precomputed aggregate values that enable the system to provide context to the input transactions and will enable the system to provide a transaction score in real time.

There is no prior art that is capable of using multiple heterogeneous streams as inputs to train the same machine learning regression or classification models, in order to score and classify heterogeneous events from different sources with that same model.

### OVERVIEW OF THE INVENTION

The current invention relates to a method and system for applying a centralized artificial intelligence system, trained in batch using a centralised data set having a known dataset schema, to score events from multiple streams of data.

Given a raw dataset, with a known dataset schema, an optional step is to expand it with a set of aggregate features computed in batch and adding information regarding the context in which a transaction occurred in. As an example, given a payment transaction involving card A and merchant 1, features are computed and added to this transaction, such as the average amount of money spent with this card, the standard deviation for this value, as well as the average amount of money spent on this merchant and the corresponding standard deviation for this value. Such aggregate features are added per country, per issuing bank, for each individual credit or debit card, per merchant, per merchant category code (MCC) etc.

The AI system will then be trained using several different algorithms such as gradient boosted trees and deep neural networks. This process is rather straightforward and machine learning models are obtained, that are then serialised.

These serialised models are then imported into a container that will serve them in real time. This container exposes an endpoint that the customers can connect to and an API that can be used to send requests to the application. These requests consist conceptually of transactions which may be on a different data schema than the one that is used to train the models on.

Given this new transaction, it is mapped on the fly into the data source schema that is known and a transaction with a signature that is akin to transactions in the raw dataset is obtained, but still different to the ones that are used to train the models on. This transaction will now have to be expanded and to make it look like the ones that are used to train the models on. This will be achieved by expanding the transaction with all the features necessary to provide context. In order achieve this, the system will need to be able to compute aggregates in real time, which will only be possible if those aggregates are pre-processed, as otherwise the latency (linked to the time required to make the necessary computations of such aggregates) would be too high. After this expansion is done, a transaction that looks like the transactions that are used to train the models is obtained and it can then be scored using the centralised AI.

After having obtained a score for this transaction, this score is immediately sent back to the customer. After sending the transaction score, the aggregate values that are relevant for this specific transaction are updated, namely the rolling average amount spent using this card, the rolling average spent on this merchant, the average ticket value for this merchant category code and all associated standard deviations.

All of these aggregate values are stored in the data source, specifically a key-value store. Updates to this store are then local and constant in terms of computational complexity. The spatial complexity is linear on the amount of transactions that have been processed, however, the same transaction has an impact on multiple aggregates.

### BRIEF DESCRIPTION OF THE DRAWINGS

These and other features can be readily understood by the accompanying drawing. The drawing is included for illustrative purposes.

FIG. 1 is a schematic overview of the scoring application and the workflow of the method claimed in the current invention.

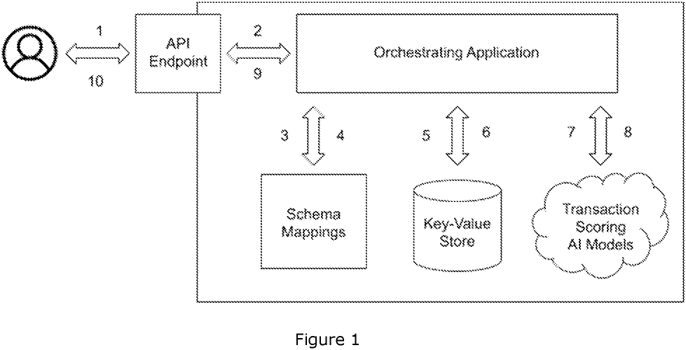

FIG. 1 makes reference to the following method components:
1 - 3 : Atomic event
4 : Transformed event
5 : Keys
6 : Values
7 : Contextualised event
8 - 10 : Score/Classified event

### DEFINITIONS

Some definitions of the terms used in the current document are listed below.

### Ai

AI is an acronym that corresponds to Artificial Intelligence. It is defined as the automatic computation and analysis of the surrounding environment and the ability for a system to autonomously interpret and analyse data and provide results.

### Machine Learning

Machine learning is an application of artificial intelligence (AI) providing systems the ability to automatically learn and improve from experience, in the form of data, without the need to explicitly program them. The focus of Machine learning is the development of computer programs that can access data and use it to learn for themselves. In terms of the current invention, the learning process starts with past observations, or data, and the learning algorithm looks for patterns that are capable of adequately modelling the past and have the power to make good decisions in the future. The primary aim is to allow computers to learn automatically without human intervention or assistance and adjust their actions accordingly.

### Regression, Classification and Clustering

Regression and classification are supervised learning tasks that require mapping an input to an output based on example input-output pairs, while clustering is a so-called unsupervised learning approach.

### Regression

In a regression task, one aims to predict a continuous valued output. Regression analysis is the method used to produce a model that can predict a continuous numeric output given a set of inputs. It can also identify distribution trends based on available input data. E.g.: To predict a person’s income from their age, level of education and postal code.

### Classification

In a classification task, is intended to predict one or more discrete values with no implicit or explicit order. In classification the data is categorized under different labels according to input features. To classify emails as being either spam or not spam is an example of a classification problem.

### Clustering

In a clustering task, is intended to partition a dataset into groups, called clusters. The goal is to split up the data in such a way that points within each cluster are similar and points from different clusters are different. After characterising such clusters as being predominantly composed of data points having one specific class, a new data point can be classified by determining the cluster it better fits into and then assigning it the predominant class of that cluster. This is called classification by clustering. The same reasoning can be employed for doing regression by clustering if a distance metric is used to determine the degree of belonging to the cluster the new data point fits into.

### Supervised Learning

Supervised learning is the machine learning task of learning the function that best possibly maps an input to an output based on a dataset with input-output pairs. In other words, it infers a function from a labelled set of training data. In supervised learning individual examples are pairs consisting of an input object (typically a vector consisting of features) and a corresponding desired output value (also called the label, the class, the category or the supervisory signal). Such algorithms analyse the training data and produce an inferred function (also called a model), which can then be used for mapping new example inputs to predicted outputs. In an ideal scenario, this model will allow us to correctly determine the class labels for unseen instances. This implies that the learning algorithm is capable of generalizing from the training data to unseen events in a reasonable way.

### Unsupervised Learning

Unsupervised learning is a type of machine learning that looks for previously undetected patterns in a data set with no pre-existing labels and with a minimum of human supervision. In contrast to supervised learning that usually makes use of human-labelled data, unsupervised learning, also known as self-organization allows for modelling of probability densities over inputs. It forms one of the three main categories of machine learning, along with supervised and reinforcement learning. Semi-supervised learning, a related variant, makes use of supervised and unsupervised techniques.

### Reinforcement Learning

Next to the two main branches of Machine Learning - Supervised Learning and Unsupervised Learning - a third branch exists called Reinforcement Learning (RL). RL is a paradigm that does not directly rely on data, but instead on experience gained by an agent’s interaction with a (simulated) environment. Its theory models much of animal and human decision making.

The agent’s goal is to learn good strategies for sequential decision problems within this environment, by taking actions to explore it. Each action results in some event, either positive or negative (rewards). Over time agents learn to optimize their actions to maximize these rewards, thereby finding optimal strategies. By designing environments, actions and rewards in specific ways, almost any problem can be solved this way. E.g.: If the goal is to get a mapping function that returns the best matching target feature in one dataset for every source feature in another dataset, then it is possible to define the state as a representation of the data that is attempted to map from. Actions change the current mapping function and the rewards (a value from the reward function) signal how good the new state (a given mapping), obtained as a consequence of taking an action, is.

### Data Set Schemas

Schemas describe a data set’s syntactic characteristics like data types, number, name and order of features. Two data sets can be syntactically different, and thus look different to the human eye, but in fact represent information that is comparable from a semantic perspective. Think of a basic 2 column data set: Column A represents a person’s name and column B a person’s age. Swapping those two columns entirely does not change their informational value, but will make a pre-trained model fail, because it expects numbers in column B. This way, for the same underlying semantics, different schemas manage to capture the same data in different ways. Such ambiguity poses a challenge to modern machine learning models that heavily rely on consistent dataset schemas. Resolving this ambiguity is a process called schema matching, a well-established problem that intersects the domains of database systems, knowledge representation, machine learning and information retrieval. It is essentially a discrete combinatorial optimization problem: Among the very large number of possible schemas, only a small subset is suitable for model prediction and an even smaller subset maximizes model performance.

### Low Latency

Low latency in the field of computer systems and in particular throughout this document is defined as an operation that will take less than 100 milliseconds to complete.

Traditional natural language processing normalizations and transformations: A process which converts heterogeneous sequences of words to a more homogeneous sequence of words. Used for preparing open text for later processing. By transforming the words to a standard format, other operations are able to work with the data and will not have to deal with issues that might compromise the process. For example, converting all words to lowercase will simplify the searching process. The normalization process can improve text matching. For example, there are several ways that the term “modem router” can be expressed, such as modem and router, modem & router, modem/router, and modem-router. By normalizing these words to the common form, it makes it easier to supply the right information to a shopper.

### Transfer Learning

Transfer learning can be defined as the transfer of information from a related source domain to a target domain to improve a learner. The motivation to do so is when training data for a target domain is unavailable or limited as it can be difficult or expensive to obtain. The main elements of Transfer Learning consist of a domain and a task, which can be distinguished into cases where either the source domain is a bit different from the target domain or the source task is a bit different from the target task. The former relates to cases where the feature space and/or marginal distributions are different and the latter cases where the label and/or conditional distributions are different. Methods of transfer learning which try to alter the source domain to be closer to the target domain is called domain adaptation.

General approaches can be categorized into instance-based, feature-based, shared-parameter models and based on defined relationships. Feature-based can be further categorized into asymmetric and symmetric transformations. Asymmetric transformations aim at finding a comment latent space between the two to reduce the difference in marginal distributions and to improve the predictive qualities. A symmetric transformation directly transforms from one to another, for example by reweighting the instances to represent the target domain more closely. Transfer learning is most popular for sharing parameters of a source model, where most of the top layers are frozen for updates and used as extractors of general features for other classification models. The final layers can be used for initialization in order to be fine-tuned and to allow the model to be more domain specific. Depending on the difference in domain and amount of data, more layers can be fine-tuned or initialized from scratch.

### Regular Expression Transformations

A regular expression is a sequence of characters that define a search pattern. Such patterns are used by string-searching algorithms to “find and replace” operations on strings. A regular expression, also called a pattern, characterises a set of strings that are required for any given purpose. A trivial way to specify a finite set of strings is to explicitly list all of its elements. There often are more concise ways though: as an example, the set containing the three strings “Nurburgring”, “Nürburgring”, and “Nuerburgring” can be specified by the pattern N(ü|üe?)burgring; It is said that this pattern matches each of the three aforementioned strings.

### DETAILED DESCRIPTION OF THE INVENTION

The current invention relates to a method for scoring events from multiple heterogeneous input streams with low latency using machine learning.

The current invention is intended for use, preferably but not limited to, in connection to a system for detecting fraud related to card payments. Among other uses, it will provide a low latency method for detecting frauds associated with credit or debit card transactions.

A first optional step that needs to be taken is to warm up an internal data source, preferably a key value store, before it is possible to retrieve and update aggregate values. This is done by the precomputation of aggregate values obtained from data received from clients, for all the necessary keys in batch, as a job that runs on a big data system. In a preferred embodiment, the precomputation of aggregate values obtained from data received from a client is performed in a Spark cluster.

A module of the system reads the keys and values from the Spark cluster and loads them up into an internal data source, preferably a Key-value store. Redis is a preferred embodiment of the in-memory store for storing key-value pairs, whereas Spark is an embodiment of the big data processing system that is used to compute the aggregates for each of the keys.

The warm up of the internal data source is done in in two steps:

1. Produce files containing all the Key-Value pairs and export them from the big data system. These files can contain Billions of key-value pairs.

2. Import such files into a Key-Value Store: Here the files are read and the pairs are introduced into a Key-Value store.

Upon completion of the warm up of the internal data source, the system will then be able to retrieve data from the data source in order to be able to classify and store individual events that are received from the client at the systems input stream.

The method receives atomic events from input streams. These input streams may be, but are not limited to, transaction requests from financial services. An atomic event is characterized as being an out of context event, containing only the specific information regarding that sole event.

The method will then proceed to transform the atomic event into a centralized dataset schema, in order to be able to apply the internal system methodology to that specific event. In order to prepare the event for processing by the system’s method, several transformation procedures are executed. The transformation of the inbound atomic event into a centralized dataset schema is performed by applying at least one of the following input data preparation models: Traditional NLP normalizations, regular expression based transformations, or more complex Reinforcement Learning and Transfer Learning based transformations.

One embodiment of this schema mapping approach is a function that uses reinforcement learning to map one source dataset X into one target dataset Y. Rewards are split two-fold into syntactic and semantic parts. The syntactic part is maximized when both source and target data sets look structurally similar. The semantic part is maximized when a fixed supervised ML model performs similarly on both data sets.

The implementation of the step of transformation of the atomic event into a centralized dataset schema is detailed below, where practical examples are listed for better understanding of this step of the current invention.

Given one fully trained supervised machine learning model, capable of scoring and classifying events from centralised dataset Y having schema A and distribution 1, this model is reused to accurately predict for data points belonging to new dataset X:
1. Having different schema B and same distribution 1
2. Having the same schema A and different distribution 2

For this, a distinction between a “mapping model” and a “core model” will be made. The core model in this context refers to a neural network trained with the system’s centralised dataset Y in order to do backpropagation for the mapping model. The mapping model can be modelled in different ways and will be trained based on the fraud classification objective on new dataset X.

One way to model this is by connecting the new incoming datasets with a fully connected network to the core model. The resulting model is a large and fully connected model that is able to predict a score for a previously unseen dataset.

A second approach that is taken is to first do some syntactic matching of columns between the two datasets via schema matching techniques (Reinforcement Learning, regular expression transformations and other traditional NLP transformations are some of those techniques). This will limit the amount of connections between neurons in the mapping model’s network compared to using a fully connected network. The mapping of (semantic) column values is then still done by resorting to the classification objective with the core model.

Another approach that is implemented is to make use of auto encoders, a type of neural network architecture used to learn efficient data codings in an unsupervised manner. An auto encoder is trained for each of the datasets in order to learn an intermediate representation and use the encoder and decoder separately after that. The encoder of the new dataset X can be connected with the decoder of the centralised dataset Y. Then only the decoder will need to be updated for optimization. Furthermore, the intermediate representation may also be used as (additional) input for the core model.

A further optional step of the method is to proceed to obtain relevant contextualization data for the transformed atomic event with all aggregate values retrieved from the internal data source that have previously been computed for all relevant fields in the event. This is done by mapping the atomic event with the mapping functions, obtaining a transformed atomic event (or in short, transformed event), and then adding information from the internal data source to this transformed event, obtaining a contextualised transformed event (or in short, contextualised event). This will allow to have a more in-depth knowledge and understanding of the event at stake, and will allow the system to identify different parameters and characteristics that will help classify the event. The information contained in the internal data source has been previously obtained by the bulk processing of the information made available by the client that is using the system. In a preferred embodiment the internal data source is implemented resorting to the use of a key-value store that will allow for rapid data access.

With the fully contextualized transformed event and the environment variables that characterize the event, the method will now proceed with scoring the contextualized transformed event, establishing whether the event conforms to the usual procedures or if it results in a deviation from the environments that characterizes these events.

Having obtained the score, the method will then return the score of the contextualized transformed event immediately to the user that sent the atomic event. This will allow the event provider to take measures according to the event’s score obtained from the system.

An additional optional step will be to proceed to update the internal data source with the values from the contextualized transformed event, in order to update the environment variables and context that will be used with future events classification.

In a further embodiment of the current invention, the system returns a score and a binary classification for each event, rather than just a score. In this embodiment, an initial cutoff threshold for each classification is defined. With the obtention of the score for the contextualized transformed event, this score is analysed against the cutoff threshold and the corresponding classification is obtained. In this embodiment, the cutoff threshold defined for each classification is dynamically increased if the number of negative classifications deviates from the expected distribution, and the cutoff threshold defined for each classification is dynamically decreased if the number of positive classifications deviates from the expected distribution. The expected distribution is defined as the expected number of positive and negative scores obtained for the events received from a client. In this embodiment, the cutoff threshold defined for each classification is defined by the use of models trained using at least one of the following regression, classification or classification by clustering machine learning algorithms:
● Gradient Boosted Trees;
● Random Forests;
● Support vector machines.
● Deep Neural Networks;
● Logistic Regression, including but not limited to Lasso and Ridge regression;
● K-nearest neighbours;
● Naive Bayes;
● K-means.

### EXAMPLES

### Example 1

In an example usage of the current invention, the described method will be applied to detect fraud in card payment transactions using cards issued by a given card issuing bank.

Data of past transactions is received from a client and is used to warm up the internal data source. All transaction values are precomputed in batch to obtain and store the aggregate values that will enable the immediate obtention of values from the internal data source. Examples of the precomputed aggregate values include the usual amount spent by all merchants included in the data received, the usual amount spent when transactioning each item included in the data received, the usual amount spent in a specific type of item, among additional aggregate information.

The method will receive as an input a transaction from the client that was performed by a card holder. This transaction is considered the atomic event. This transaction contains all atomic information associated with a card transaction and is, at this stage, an out-of-context event. It contains information such as, the amount of the transaction, the merchant involved in the transaction, the location in which the merchant is located, the item being transacted, among other information.

The atomic transaction will be transformed into the method’s centralized dataset schema, in order to be able to apply the internal system methodology to this specific transaction.

The transaction will then be contextualized by information obtained from the internal data source. The atomic transaction will be completed with information that relates to the specific transaction, such as the usual amount spent at the merchant involved in the transaction, the usual amount spent when transactioning the item being transacted, the amount the item is usually transacted for in the location in which the merchant is located, among other information.

The transaction is at this point contextualized with information relating to the specific transaction that is being scored.

The method will now score the transaction, by identifying whether the transaction is within the usual parameters that characterize the transactions with the specific information. The scoring will be based on whether the transaction conforms to the usual characteristics or if it deviates from the usual characteristics. A transaction score is obtained at this step.

The obtained score is then immediately forwarded to the client. The client will act according to the score that was obtained for the specific transaction, namely it will classify the transaction as fraudulent or non-fraudulent.

The internal data source will then be updated with all information associated with the contextualized and scored transaction, in order to be able to score future transactions based on the characteristics and score of the current transaction.

### Example 2

In an additional example usage of the current invention, the described method will be applied to identify money laundering processes related to financial transactions.

Data of past financial transactions that occurred between a client and different senders/receivers is obtained from the client and used to warm up the internal data source. All financial transaction values are precomputed in batch to obtain and store the aggregate values that will enable the immediate obtention of values from the internal data source. Examples of the precomputed aggregate values include the usual amount that is transacted between the client and the respective senders/receivers, the location of the different senders/receivers, the intermediate institutions that enable the financial transactions, among additional aggregate information.

The method of the current invention will receive as an input from the client one or more financial transactions that will correspond to the financial set of transactions to score, in which a sender performs one or more financial transactions directed to a receiver. The set of these financial transactions are considered the atomic event. This set of financial transactions contains all atomic information associated with usual financial transactions and is, at this stage, an out-of-context event. It contains information such as, the amount involved in the financial transactions, the sender of the financial transactions, the receiver of the financial transactions, the location in which the sender is located, the location in which the receiver is located, among other information.

The set of the atomic transactions will be transformed into the method’s centralized dataset schema, in order to be able to apply the internal system methodology to this specific set of financial transactions.

The set of financial transactions will then be contextualized by information obtained from the internal data source. The set of the financial transactions will be completed with information that relates to the specific transactions, such as the usual amount that is sent by the sender involved, the usual amount that is received by the receiver, the usual amount that is sent in the sender’s location, the amount that is usually received at the receiver’s location, among other information.

The set of the financial transactions is at this point contextualized with information relating to the specific set that is being scored.

The method will now score the set of financial transactions, by identifying whether the set is within the usual parameters that characterize financial transactions with the specific information. The scoring will be based on whether the set of financial transactions conforms to the usual characteristics or if it deviates from the usual characteristics. A score related to this specific set of financial transactions is obtained at this step.

The obtained score is then immediately forwarded to the client. The client will act according to the score that was obtained for the specific set of financial transactions, namely it will allow the client to identify if this set relates to procedures involved in money laundering mechanisms.

The internal data source will then be updated with all information associated with the contextualized and scored set of financial transactions, in order to be able to score future sets based on the characteristics and score of the current set.

1. Method for scoring financial transactions from multiple heterogeneous input streams in real-time using machine learning, comprising the steps of:
a. Aggregating data input streams, each with different data schemas and each being composed of atomic transactions into a centralized data stream with a known data schema, composed of translated transactions, comprising the sub-steps of:
i. Obtaining a mapping function which returns the best matching target feature in the centralized dataset for every source feature in the input stream;
ii. Transforming each atomic event in the input stream with the mapping function into transformed transactions;
iii. Adding all transformed transactions to the centralized dataset;
b. Using the centralized dataset with a known dataset schema to produce machine learning models, comprising the sub-steps of:
i. Splitting up the dataset into clusters, in such a way that transactions within each cluster are similar and transactions from different clusters are different
ii. Computing aggregated contextual information within and across each cluster;
iii. Running machine learning model training in batch for each cluster, producing one model for each cluster;
c. Serving the machine learning models by importing them into a container that will serve them in real time;
d. Scoring individual transactions from heterogeneous input streams, comprising the sub-steps of:
i. Receiving an atomic transaction from an input stream;
ii. Transforming of the atomic transaction into the centralized dataset schema;
iii. Adding contextualizing information to the transformed eventtransaction, obtaining a contextualized transaction;
iv. Selecting the model produced from the cluster of data to which the present contextualized transaction has the highest degree of belonging;
v. Using the selected model to score the contextualized transaction;
vi. Returning the score for the contextualized transaction.

2. Method according to claim 1, characterized in that serving the machine learning models trained for each cluster further comprises the additional preparation steps of:
a. Warming up an internal data source by precomputing aggregate values obtained from previously received data;
b. Contextualizing the transformed atomic transaction with all aggregate values retrieved from the internal data source that have previously been computed for fields present in historical transformed atomic transactions;
Updating the values taken from the internal data source to contextualize the transaction, using the corresponding values in the transformed eventtransaction.

3. Method according to claim 2, characterized in that the internal data source is a key-value store.

4. Method according to claim 2, characterized in that the precomputation of aggregate values obtained from data received from a client is performed with a big data processing system.

5. Method according to claim 4, characterized in that the query answering system is a Spark cluster.

6. Method according to claim 1, characterized in that the transformation of the atomic transaction into one with a centralized dataset schema is performed by applying at least one of the following input data transformation functions:
Traditional natural language processing normalizations and transformations;
Reinforcement learning;
Transfer learning;
Regular expression based transformations.

7. (canceled)

8. Method according to claim 1, characterized in that a classification is obtained from the score of the contextualized transformed transaction and a cutoff threshold is defined for each classification.

9. Method according to claim 8, characterized in that the cutoff threshold defined for each classification is defined by the use of models trained using ensembles of at least one of the following regression, classification or classification by clustering machine learning algorithms:
Gradient Boosted Trees;
Random Forests;
Support vector machines;
Deep Neural Networks;
Logistic Regression, including but not limited to Lasso and Ridge regression;
K-nearest neighbors;
Naive Bayes;
K-means.

10. Method according to claim 8, characterized in that the cutoff threshold defined for each classification is increased if the number of negative classifications deviates from an expected distribution.

11. Method according to claim 8, characterized in that the cutoff threshold defined for each classification is decreased if the number of positive classifications deviates from an expected distribution.

12. Method according to claim 1, characterized in that the split of the centralized dataset into clusters of transactions is performed using unsupervised clustering.

13. Method according to claim 1, characterized in that the split of the centralized dataset into clusters of transactions is performed by aggregating by combinations of industry code (MCC), merchant country, bank country, debit or credit card, merchant.

14. Method according to claim 8, characterized in that each model created from each cluster contains a cutoff threshold.

15. Method according to claim 1, characterized in that the score obtained allows the classification of the transaction as fraudulent or non-fraudulent.
